(19) United States
(12) Patent Application Publication
(10) Pub. No.: US 2010/0074712 A1
(43) Pub. Date: Mar. 25, 2010

(54) CLINCH BOLT

(75) Inventor: Kimio SHINJO, Osaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: PIAS Sales Co., Ltd.

(21) Appl. No.: 12/562,241

(22) Filed: Sep. 18, 2009

(30) Foreign Application Priority Data
Sep. 19, 2008 (JP) JP2008-240377

(51) Int. Cl. F16B 39/00

(52) U.S. Cl. 411/337

(57) ABSTRACT

To present a clinch bolt capable of obtaining a stable clinching force without causing misalignment between the mounting hole provide in a metal plate and an annular groove of the clinch bolt. A clinch bolt 21 having crimping protuberances 25 formed on a seat surface 24 of a head part 23, having an annular ridge part 26 of a larger diameter than the outside diameter of a screw shaft part 22 formed in an under-neck portion immediately beneath the seat surface 24, and having an annular groove 27 formed between the annular ridge part 26 and the seat surface 24, for inserting the screw shaft part 22 into a mounting hole 11 slightly larger than the outside diameter of the annular ridge part 26 pierced into a metal plate 10, pressing the head part 23 to the metal plate 10, press-fitting the crimping protuberances 25 into the peripheral edge 12 of the mounting hole 11, and crimping and deforming the peripheral edge 12 to bite into the annular groove 27, so as to be fixed tightly to the metal plate 10, in which at least three misalignment preventive protuberances 28 projecting from the wall 27a of the annular groove 27 in the radial direction are disposed at appropriate intervals in the circumferential direction, and the leading ends of the misalignment preventive protuberances 28 are disposed on a virtual circumference of nearly same diameter as the diameter of the annular ridge part 26.

### BACKGROUND OF THE INVENTION

1. Field of the Invention

The present invention relates to a clinch bolt for fixing by crimping and coupling, by inserting a screw shaft part into a mounting hole pierced in a metal plate, and pressing a head part to the metal plate.

2. Background Art

For example, a clinch bolt 1 is hitherto known as shown in FIG. 11 and FIG. 12, in which crimping protuberances 5 are provided on a seat surface 4 of a head part 3, an annular ridge part 6 of a larger diameter than the outside diameter of a screw shaft part 2 is formed in an under-neck portion immediately beneath the seat surface 4, and an annular groove 7 is formed between the annular ridge part 6 and the seat surface 4, and more specifically the screw shaft part 2 is inserted into a mounting hole 11 slightly larger than the outside diameter of the annular ridge part 6 pierced into a metal plate 10, the head part 3 is pressed to the metal plate 10, the crimping protuberances 5 are press-fitted into the peripheral edge 12 of the mounting hole 11, and the peripheral edge 12 is crimped and deformed to bite into the annular groove 7, so as to be fixed tightly to the metal plate 10.

Since the mounting hole 11 pierced in the metal plate 10 for fixing the clinch bolt 1 has a slightly larger diameter than the annular ridge part 6, when the screw shaft part 2 is inserted into the mounting hole 11, and the crimping protuberances 5 protruding from the seat surface 4 of the head part 3 are positioned to abut against the metal plate 10, a considerable dimensional difference exists between the inner periphery 11a of the mounting hole 11 and the wall 7a of the annular groove 7. Hence, in particular, when the metal plate is thin, as shown in the drawing, a misalignment may occur between the mounting hole 11 in the metal plate 10 and the annular groove 7 of the clinch bolt 1. If the head part 3 is pressed, crimped and coupled into the metal plate 10 in such misaligned state, the deformation amount of the peripheral edge 12 of the mounting hole 11 biting into the annular groove 7 by crimping and deforming is not uniform, and the clinching force may be insufficient.

### SUMMARY OF THE INVENTION

It is hence an object of the present invention to solve the problems of the prior art by presenting a clinch bolt capable of obtaining a stable clinching force, without occurrence of misalignment between the mounting hole in the metal plate and the annular groove of the clinch bolt.

To achieve the object, the present invention provides a clinch bolt having crimping protuberances formed on a seat surface of a head part, having an annular ridge part of a larger diameter than the outside diameter of a screw shaft part formed in an under-neck portion immediately beneath the seat surface, and having an annular groove formed between the annular ridge part and the seat surface, for inserting the screw shaft part into a mounting hole slightly larger than the outside diameter of the annular ridge part pierced into a metal plate, pressing the head part to the metal plate, press-fitting the crimping protuberances into the peripheral edge of the mounting hole, and crimping and deforming the peripheral edge to bite into the annular groove, so as to be fixed tightly to the metal plate, in which at least three misalignment preventive protuberances projecting from the wall of the annular groove in the radial direction are disposed at appropriate intervals in the circumferential direction, and the leading ends of the misalignment preventive protuberances are disposed on a virtual circumference of nearly same diameter as the diameter of the annular ridge part.

To prevent the inner periphery of the mounting hole from being engaged with the annular groove, preferably, the lateral sectional shape of the misalignment preventive protuberances is formed in a pointed triangular or pentagonal shape, or in a narrow trapezoidal or rectangular shape. At least three protuberances are needed, and up to five may be preferred in order to prevent the inner periphery of the mounting hole from being engaged with the annular groove.

Preferably, the outer edge of the misalignment preventive protuberances is formed in a taper shape spreading widely from the outer periphery of the annular ridge part toward the seat surface, and when the screw shaft part is inserted into the mounting hole until the seat surface of the head part is closer to the metal plate, the tapered outer edge of the misalignment preventive protuberances contacts with the inner periphery of the mounting hole, and is aligned by the automatic centering action, and misalignment can be effectively prevented.

As explained herein, according to the present invention, in a simple configuration having at least three misalignment preventive protuberances projecting from the wall of the annular groove in the radial direction formed between the annular ridge part provided in the under-neck portion immediately beneath the seat surface of the head part and the seat surface, it is effective to prevent securely misalignment between the mounting hole in the metal plate and the annular groove, and therefore a stable clinching forced is obtained.

### BRIEF DESCRIPTION OF DRAWINGS

FIG. 1 is a front view of a clinch bolt of the present invention.

FIG. 2 is a bottom view of the same as seen from the screw shaft part side.

FIG. 3 is a magnified sectional view along line 3-3 in FIG. 1.

FIG. 4 is an essential part longitudinal front view showing a preparatory step before crimping process for fixing the clinch bolt to a metal plate.

FIG. 5 is an arrow sectional view along line 5-5 in FIG. 4.

FIG. 6 is an essential part longitudinal front view showing a coupling step of fixing the clinch bolt to a metal plate.

FIG. 7 is an arrow sectional view along line 7-7 in FIG. 6.

FIG. 8 is an essential plan view showing other preferred embodiment of misalignment preventive protuberances in the clinch bolt.

FIG. 9 is an essential part longitudinal front view showing a preparatory step before crimping process for fixing the clinch bolt of the present invention to a metal plate having misalignment preventive protuberances in another preferred embodiment.

FIG. 10 is an essential part magnified explanatory diagram of the same.

FIG. 11 is an essential part longitudinal front view showing a preparatory step before crimping process for fixing a conventional clinch bolt to a metal plate.

FIG. 12 is an arrow sectional view along line 12-12 in FIG. 11.

### DETAILED DESCRIPTION OF THE INVENTION

Referring now to the drawings, preferred embodiments of the present invention are specifically described below.

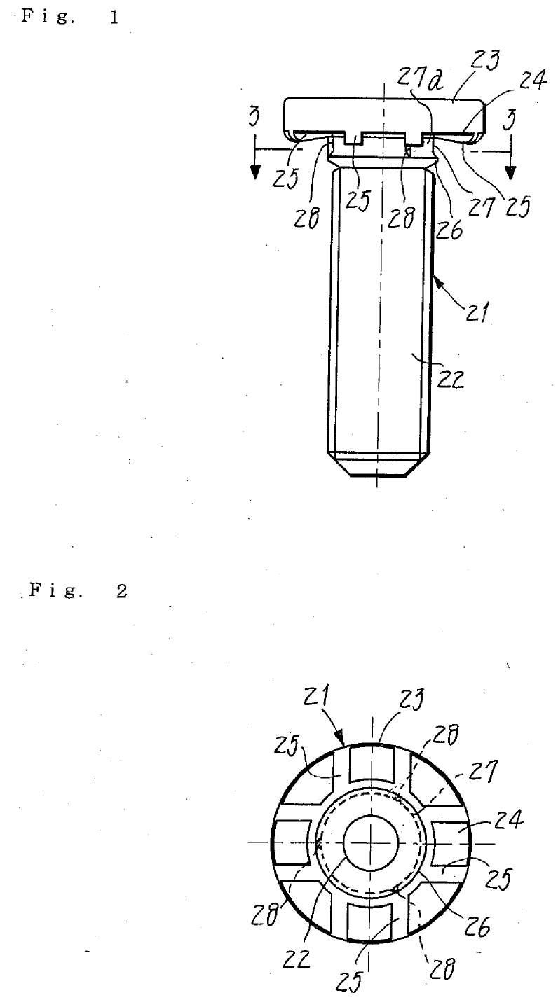

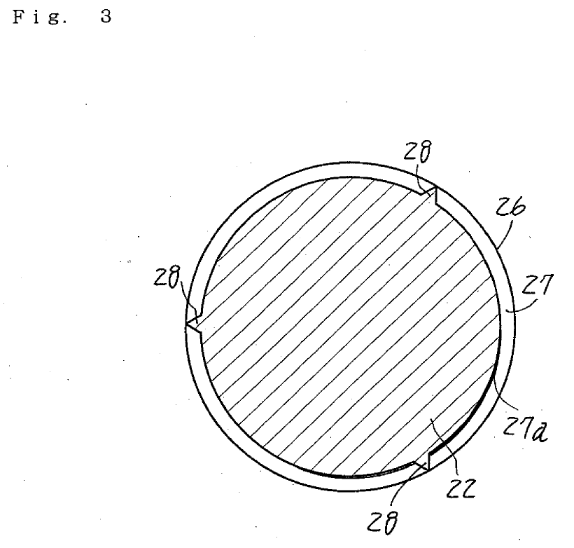

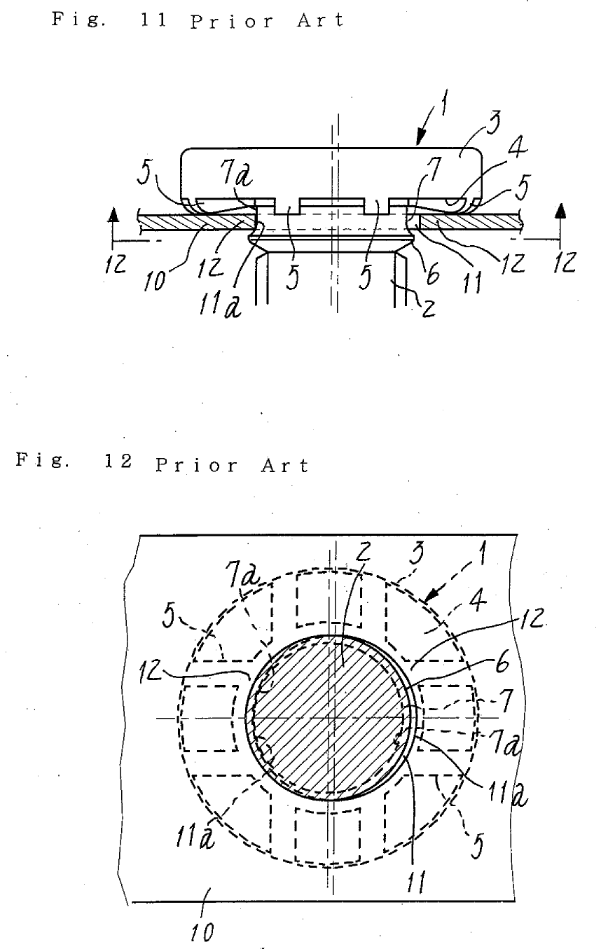

FIG. 1 to FIG. 3 show the clinch bolt of the present invention. The basic configuration of the clinch bolt 21 is common to the conventional clinch bolt 1 shown in FIG. 11 and FIG. 12, that is, crimping protuberances 25 are projecting like a lattice from a seat surface 24 of a head part 23 consecutively provided at the upper end of a screw shaft part 22, and each crimping protuberance 25 is gradually increased in thickness from the inside to the outside of the seat surface 24. In the under-neck portion immediately beneath the seat surface 24, an annular ridge part 26 of a larger diameter than the outside diameter of the screw shaft part 22 is projecting, and an annular groove 27 is formed between the annular ridge part 26 and the seat surface 24, and so far the configuration is same as in the prior art, except that three misalignment preventive protuberances 28 projecting in the radial direction are provided in a wall surface 27a of the annular groove 27 at equal intervals in the circumferential direction.

The misalignment preventive protuberances 28 are more specifically shown in FIG. 3, in which the lateral sectional shape is a pointed triangular shape, and the leading end is disposed on a virtual circumference having a nearly same diameter as the diameter of the annular ridge part 26.

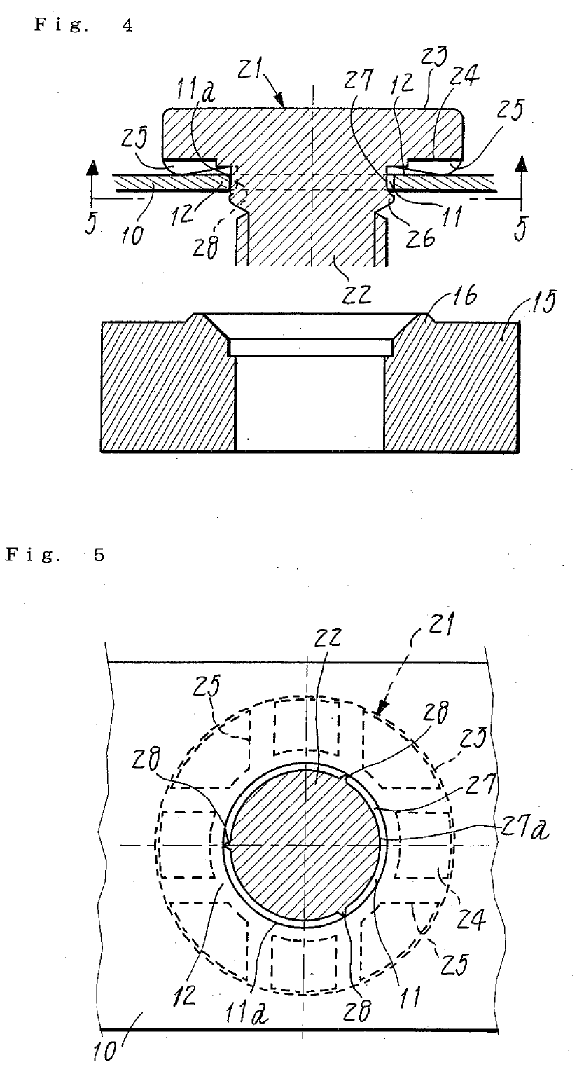

FIG. 4 to FIG. 7 show the crimping process of fixing the clinch bolt 21 having such configuration to the metal plate 10 by crimping and coupling, in which the metal plate 10 is preliminarily provided with a mounting hole 11 slightly larger than the outside diameter of the annular ridge part 26. This point is same as shown in FIG. 11.

FIG. 4 and FIG. 5 show the preparatory step before the crimping process, in which the screw shaft part 22 is inserted into the mounting hole 11, and the seat surface 24 of the head part 23 is brought closer to the metal plate 10, and each crimping protuberance 25 is in a positioning state abutting against the metal plate 10. At this time, as explicitly shown in FIG. 5, the leading ends of the three misalignment preventive protuberances 28 are engaged with the inner periphery 11a of the mounting hole 11, and they are positioned almost concentrically in a state of preventing misalignment between the mounting hole 11 and the annular groove 27. Moreover, since the lateral sectional shape of the misalignment preventive protuberances 28 is formed in a pointed triangular shape, when the screw shaft part 22 is inserted in the mounting hole 11, the inner periphery 11a of the mounting hole 11 is not prevented from being engaged with the annular groove 27. If the number of the misalignment preventive protuberances 28 is too many, the inner periphery 11a of the mounting hole 11 may be prevented from being engaged with the annular groove 27, and hence the number of the misalignment preventive protuberances 28 is not more than five. FIG. 4 shows the location of a blanking die 15 for use in a next crimping process.

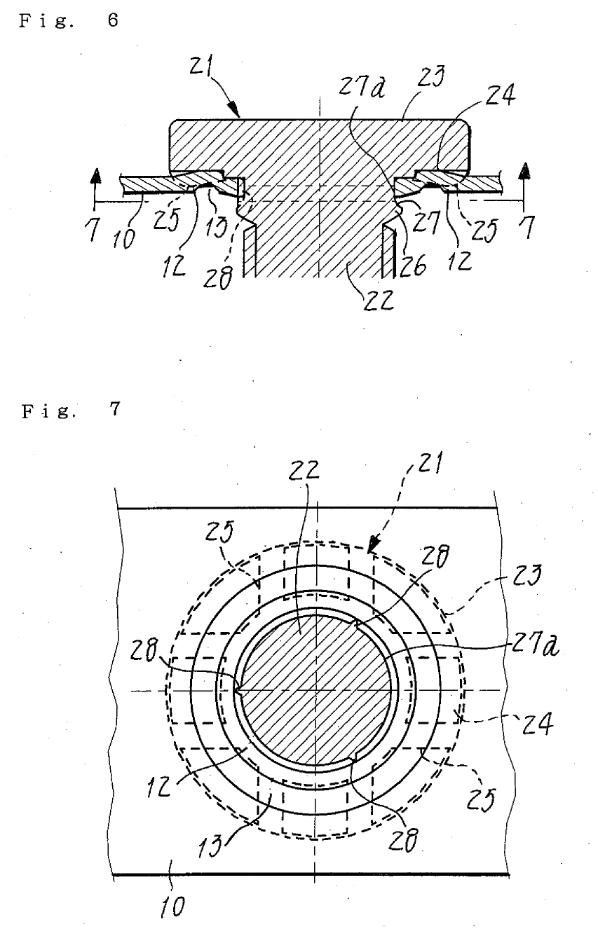

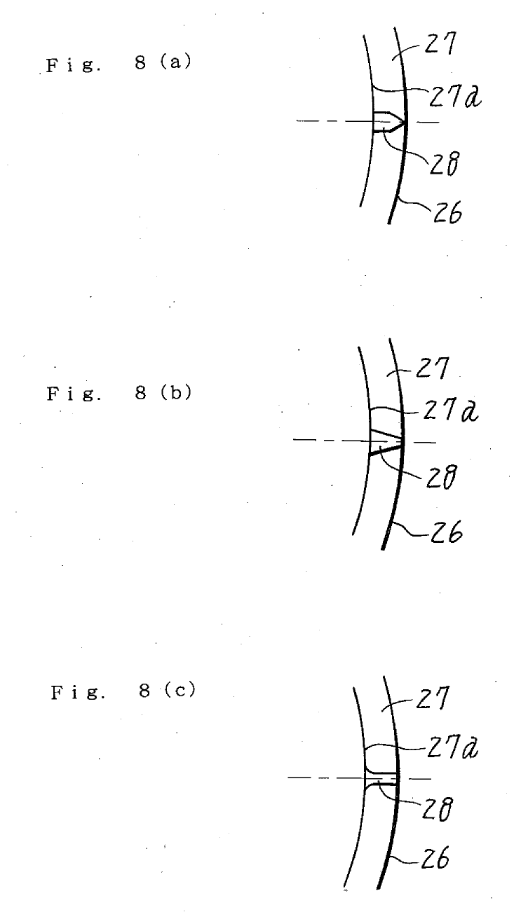

FIG. 6 and FIG. 7 show the crimping process of the clinch bolt 21, in which the head part 23 is pressed to the metal plate 10, and in cooperation with an annular projecting part 16 of the blanking die 15 shown in FIG. 4, the crimping protuberances 25 projecting from the seat surface 24 and the annular projecting part 16 of the blanking die 15 are pressed to the peripheral edge 12 of the mounting hole 11, and the peripheral edge 12 is crimped and deformed to bite into the annular groove 27, and is crimped and coupled to the under-neck portion immediately beneath the head part 23 by a stable clinching force, so that the clinch bolt 21 is fixed to the metal plate 10. At this time, an annular recess groove 13 is formed in the peripheral edge 12 by the annular projecting part 16 of the blanking die 15.

FIG. 8 shows other preferred embodiment of the misalignment preventive protuberances 28, in which (a) shows the lateral sectional shape formed in a pointed pentagonal shape, and (b) and (c) show the inner periphery of the mounting hole 11 formed in a lateral sectional shape of a narrow trapezoidal or rectangular shape so as not to interfere engagement with the annular groove 27.

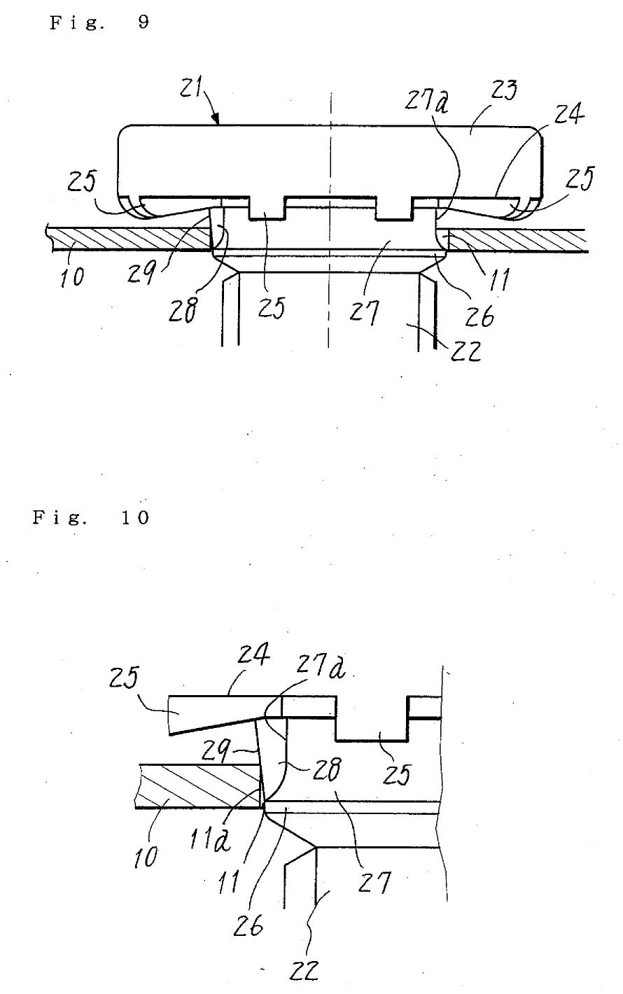

FIG. 9 and FIG. 10 show another preferred embodiment. In this preferred embodiment, the lateral sectional shape of the misalignment preventive protuberances 28 is pointed same as in the foregoing preferred embodiment, but their outer edges 29 are formed in a taper shape spreading widely toward the seat surface 24. In such configuration, when the seat surface 24 of the head part 23 is brought closer to the metal plate 10 by inserting the screw shaft part 22 into the mounting hole 11 of the metal plate 10, before the crimping protuberances 25 abut against the metal plate 10, as shown in the drawing, the tapered outer edges 29 of the misalignment preventive protuberances 28 contact with the inner periphery 11a of the mounting hole 11, and the screw shaft part 22 is aligned concentrically with the mounting hole 11 by the self-centering action, so that misalignment between the mounting hole 11 and the annular groove 27 can be securely prevented, and a more stable clinching force is obtained.

1. A clinch bolt having crimping protuberances formed on a seat surface of a head part, having an annular ridge part of a larger diameter than the outside diameter of a screw shaft part formed in an under-neck portion immediately beneath the seat surface, and having an annular groove formed between the annular ridge part and the seat surface, for inserting the screw shaft into a mounting hole slightly larger than the outside diameter of the annular ridge part pierced into a metal plate, pressing the head part to the metal plate, press-fitting the crimping protuberances into the peripheral edge of the mounting hole, and crimping and deforming the peripheral edge to bite into the annular groove, so as to be fixed tightly to the metal plate,
wherein at least three misalignment preventive protuberances projecting from the wall of the annular groove in the radial direction are disposed at appropriate intervals in the circumferential direction, and the leading ends of the misalignment preventive protuberances are disposed on a virtual circumference of nearly same diameter as to the diameter of the annular ridge part.

2. The clinch bolt of claim 1, wherein the lateral sectional shape of the misalignment preventive protuberances is formed in a pointed triangular or pentagonal shape.

3. The clinch bolt of claim 1, wherein the lateral sectional shape of the misalignment preventive protuberances is formed in a narrow trapezoidal or rectangular shape.

4. The clinch bolt of claim 1, wherein the outer edge of the misalignment preventive protuberances is formed in a taper shape spreading widely from the outer periphery of the annular ridge part toward the seat surface.
